(19) United States
(12) Patent Application Publication
(10) Pub. No.: US 2007/0033577 A1
(43) Pub. Date: Feb. 8, 2007

(54) Method and apparatus for debugging program code

(76) Inventor: Paulose Kuriakose Arackal, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,800

(22) Filed: Jul. 24, 2006

(30) Foreign Application Priority Data
Aug. 8, 2005 (IN) IN1101/CHE/2005

(51) Int. Cl. G06F 9/44

(52) U.S. Cl. 717/124

(57) ABSTRACT

The invention relates to a method and apparatus for debugging program code. In particular, a method for implementing data breakpoints using virtual memory support is described. During execution of the program code, virtual memory addresses for translation to physical addresses are provided to a directory of page translations. If the page translation entry for the virtual memory address has data breakpoint information associated with it, a hardware walker is activated. The hardware walker searches a list of data breakpoints to determine whether a data breakpoint address corresponds to the virtual memory address and, if so, program execution is discontinued.

### BACKGROUND OF THE INVENTION

Errors, or bugs, in program code can be very difficult and time-consuming to locate without the help of debugging software, also referred to as a debugger. Such software conventionally uses breakpoints, which initiate debugging actions at defined points in a program's execution. Program execution holds at a breakpoint and certain desired states, for instance the states of specified memory locations, are examined before the program proceeds further. This greatly improves the chances of errors being located and corrected.

Breakpoints are broadly divided into two categories, control breakpoints and data breakpoints, the latter also referred to as watch points. Control breakpoints specify a break condition and debugging action based on a program's control flow. For instance, a control breakpoint may be mapped to one specific instruction or sequence of instructions in the program. Data breakpoints, on the other hand, specify a break condition and debugging action based on the state of data values associated with a program. For instance, ‘stop when a value is written to integer variable var’ is a data breakpoint request that implements a data breakpoint when changes occur to the one or more memory locations associated with the program variable ‘var’.

Unlike control breakpoints, the mapping from a data breakpoint request to the instructions in a program where execution is to be stopped need not be one-to-one. For example, the above data breakpoint request could translate to many instructions that modify ‘var’, scattered throughout the program. Data breakpoints are particularly useful in tracking and pinpointing various memory corruption related problems, for instance caused by incorrect memory modifications. Instead of searching the entire program flow looking for instructions that modify a particular memory location, a data breakpoint request can be issued to give a notification wherever a memory location is updated.

Data breakpoints are generally implemented in one of three ways. A first involves the use of hardware registers to store memory locations for which data breakpoints are to be implemented, also referred to herein as data breakpoint addresses. Whilst being efficient, such implementations are costly and, since the number of registers that can be provided for data breakpoint addresses is generally limited, for example, usually up to a maximum of four depending on the processor architecture, the resulting implementations can be overly restrictive.

A second method for implementing data breakpoints involves the use of software code patching. Program code to be debugged is examined to determine those instructions whose execution could potentially modify memory locations. These unsafe instructions are replaced with ‘trap’ instructions that transfer control back to an operating system and then to a debugger or by inline branches or function calls that transfer control directly to the debugger. Software code patching techniques are generally complex and can slow down program execution considerably.

The third and generally preferred method for implementing data breakpoints is to use virtual memory support.

Virtual memory is used in computer memory management systems to increase the number of memory locations that can be accessed during program executions. For instance, whilst a computer may have 32-bit physical addressing, equivalent to 4 GB of physical memory, 48-bit virtual addressing may be employed, enabling a virtual address range of 262,144 GB. FIG. 1a illustrates an exemplary bit sequence for an address 1 in physical memory and FIG. 1b illustrates an exemplary bit sequence for an address 2 in virtual memory. Referring to FIG. 1a, the physical memory address 1 includes a physical page number (PPN) 3 of 20-bits and a physical offset (PO) 4 of 12 bits, the physical offset 4 pointing to a specific address within the physical page having the PPN 3. The virtual memory address 2 includes a virtual page number (VPN) 5 that is formed by first and second segments 6, 7. The first segment 6 is a 16-bit binary sequence referred to as the space ID. The second segment 7 is a 20-bit sequence that corresponds to the PPN 3. The virtual address 2 also includes a 12-bit virtual offset (VO) 8 that corresponds to the physical offset 4.

FIG. 2 illustrates a conventional system 10 that is used to implement data breakpoints using virtual memory support. A virtual memory array 11 is mapped onto physical memory 12, in this case random access memory (RAM), using a list of virtual to physical address translations stored in a page directory (PDIR) 13, also referred to as a page table. The PDIR 13 groups the memory translations by virtual page number, each virtual page translation forming a page directory entry (PDE) 14, within the PDIR 13. The system 10 also includes a central processing unit (CPU) 15 that includes a translation look aside buffer (TLB) 16. A TLB hardware walker 17 is provided for use in searching the PDIR 13. The CPU 15 runs an operating system (OS) environment 18, within which program code 19 to be debugged and a debugger 20 can be operated. The system 10 also includes cache memory 21, CPU registers 22 and a hard-disk 23.

In use, a debug table in the operating system 18 lists virtual memory addresses for which data breakpoints will be implemented, i.e. data breakpoint addresses. For each data breakpoint address in the debug table, the CPU 15 determines the virtual page number 5 of the address and sets the corresponding PDE 14 in the PDIR 13 such that a trap is raised to the operating system whenever an address within the page is accessed. This can be accomplished by setting a trap bit for the PDE 14. The CPU 15 then executes the program code 19. When access to data is required, the TLB 16 is consulted for virtual to physical address translation. The TLB 16 is essentially a CPU-local cache used to cache recently used PDEs 14 from the PDIR 13. Upon receiving the current virtual memory address to be accessed, the TLB 16 cache of recently accessed PDEs 14 is consulted to determine whether the required translation is present. If the PDE 14 corresponding to the current virtual memory address to be accessed is not available in the TLB 16, the TLB hardware walker 17 is activated to search the PDIR 13 for the correct PDE 14. Once found, the TLB hardware walker 17 copies the correct PDE 14 to the TLB 16. In systems that do not include a TLB walker 17, a TLB miss trap is instead raised to the operating system and the operating system searches for the PDE 14 in the PDIR 13. Once the appropriate PDE 14 has been located, the corresponding instruction of the program code 19 is executed with the translated address.

As a result of the PDE 14 having its trap bit set, a trap is raised to the operating system 18. A virtual memory trap handler consults the debug table to determine whether the virtual memory address of the current instruction is a breakpoint address and, if so, control is passed to the debugger 20, which performs a debugging action required for the breakpoint. Following this, execution of the program code is resumed.

Whilst conventional data breakpoint implementations involving virtual memory support have advantages over hardware register and code-patching implementations, a number of drawbacks remain. For instance, a trap is raised to the operating system each time a virtual memory address is accessed that is within a PDE with its trap bit set. This is irrespective of whether the virtual memory address is the particular address for which a data breakpoint is required. This results in a lack of efficiency. Also, while tracking inconsistent data updates due to timing windows, especially in multiprocessor environments or with fast input/output devices, the debugger's efficiency in tracking updates of data locations can become critical.

A further drawback of conventional data breakpoint implementations using virtual memory support is that data breakpoints cannot be implemented in the case that the data stored at a memory address is read but not actually modified by the CPU 15. This is because the data normally stored at the memory address is occasionally cached and in these circumstances can be read directly from the cache memory 21 thus bypassing the TLB 16. Accordingly, a trap is not raised to the operating system 18 and therefore debugging does not occur.

### BRIEF DESCRIPTION OF THE DRAWINGS

To aid understanding of the invention, embodiments thereof will now be described, purely by way of example, with reference to the accompanying drawings, in which:

FIG. 1a schematically illustrates a virtual memory address;

FIG. 1b schematically illustrates a physical memory address;

FIG. 2 illustrates a conventional system for implementing data breakpoints using virtual memory support;

FIG. 3 illustrates a system according to an embodiment of the invention for implementing data breakpoints using virtual memory support;

FIG. 4 illustrates a page directory entry of the system of FIG. 3;

FIG. 5 is a flow diagram illustrating the operation of the system of FIG. 3;

FIG. 6 illustrates a further system according to an embodiment of the invention for implementing data breakpoints using virtual memory support;

FIG. 7 is a flow diagram illustrating the operation of the system of FIG. 6;

FIG. 8 illustrates an alternative page directory entry of the system of FIG. 3;;

FIG. 9 illustrates a further alternative page directory entry of the system of FIG. 3; and

FIG. 10 is a flow diagram illustrating the operation of the system of FIG. 6 using the further alternative page directory entry of FIG. 9.

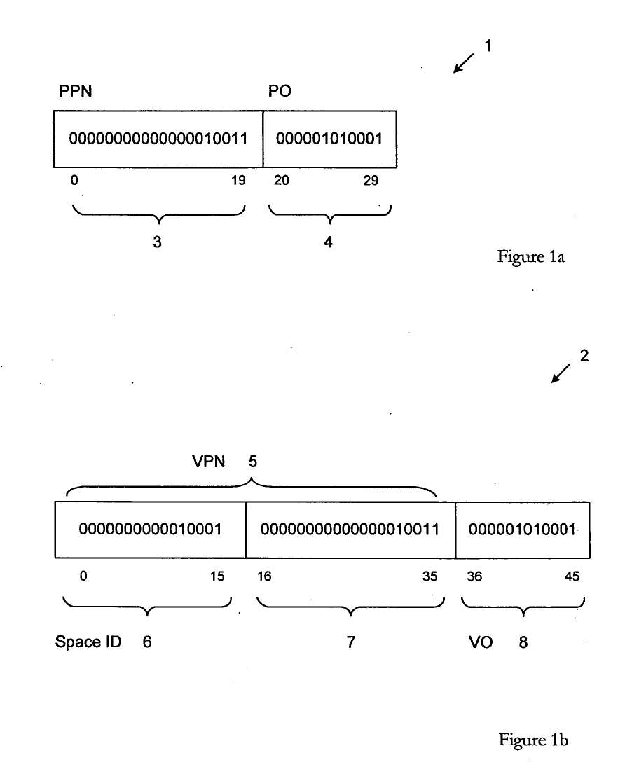

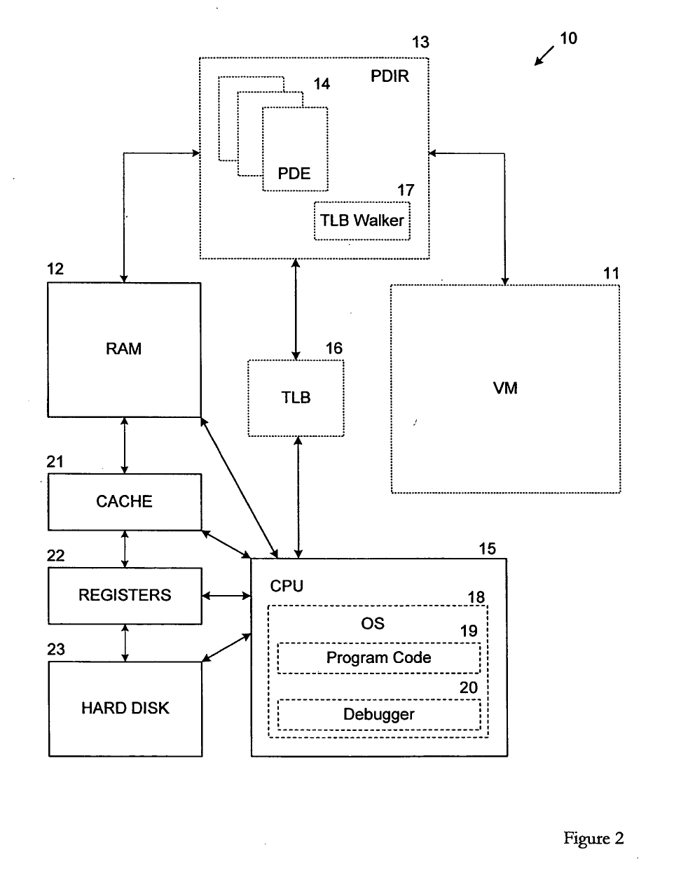

### DETAILED DESCRIPTION

There will be described a method of debugging program code, the method comprising executing the program code, receiving a virtual address associated with the program code, the virtual address being an address within a virtual page, accessing first breakpoint data, the first breakpoint data indicating whether one or more breakpoint addresses are associated with the virtual page, in the event that the first breakpoint data indicates that one or more breakpoint addresses are associated with the virtual page, accessing second breakpoint data which defines a portion of the virtual page associated with the one or more breakpoint addresses and, in the event that the virtual address is within the defined portion of the virtual page, discontinuing execution of the program code.

By accessing the second breakpoint data prior to discontinuing execution of the program code, breaks in execution can be limited to the situations in which the virtual address falls within a subset of addresses on the virtual page. Accordingly, the number of unwanted breaks in program execution are minimised thus increasing the efficiency and speed of debugging. The defined portion can comprise a single breakpoint address and the method can comprise discontinuing execution of the program code when the virtual address is the breakpoint address. The defined portion can comprise a range of addresses and the range of addresses may all comprise breakpoint addresses or at least one of the addresses in the range of addresses may comprise a breakpoint address.

The method can further comprise disabling caching of data located at one or more physical addresses, at least one of the physical addresses corresponding to a breakpoint address. Preventing caching of the data located at the physical address corresponding to the breakpoint address can ensure that the data located at the physical address is not accessed directly from the cache, which, in conventional systems, can prevent the virtual address from being received and therefore the data breakpoint address may be missed.

The method can further comprise deleting data stored at one or more cache addresses in cache memory, at least one of the cache addresses corresponding to a breakpoint address. The program code may be operable to run within an operating system environment on a computer and the step of discontinuing execution of the program code may comprise raising a trap to the operating system.

The method can further comprise accessing the second breakpoint data using a hardware walker. The method may also comprise adjusting control data for enabling or disabling the hardware walker. The second breakpoint data may be stored in a page directory entry within a page directory or in a table other than a page directory. The method can further comprise storing a value indicative of the memory location of the table in a register. The first breakpoint data can, for instance, be a debug bit associated with a page directory entry available in certain processor architectures.

There will also be described, apparatus for debugging program code, the apparatus comprising means for executing the program code, means for receiving a virtual address associated with the program code, the virtual address being an address within a virtual page, means for accessing first breakpoint data, the first breakpoint data indicating whether one or more breakpoint addresses are associated with the virtual page, means for accessing second breakpoint data in the event that the first breakpoint data indicates that one or more breakpoint addresses are associated with the virtual page, the second breakpoint data defining a portion of the virtual page associated with the one or more breakpoint addresses and, means for discontinuing execution of the program code in the event that the virtual address is within the defined portion of the virtual page.

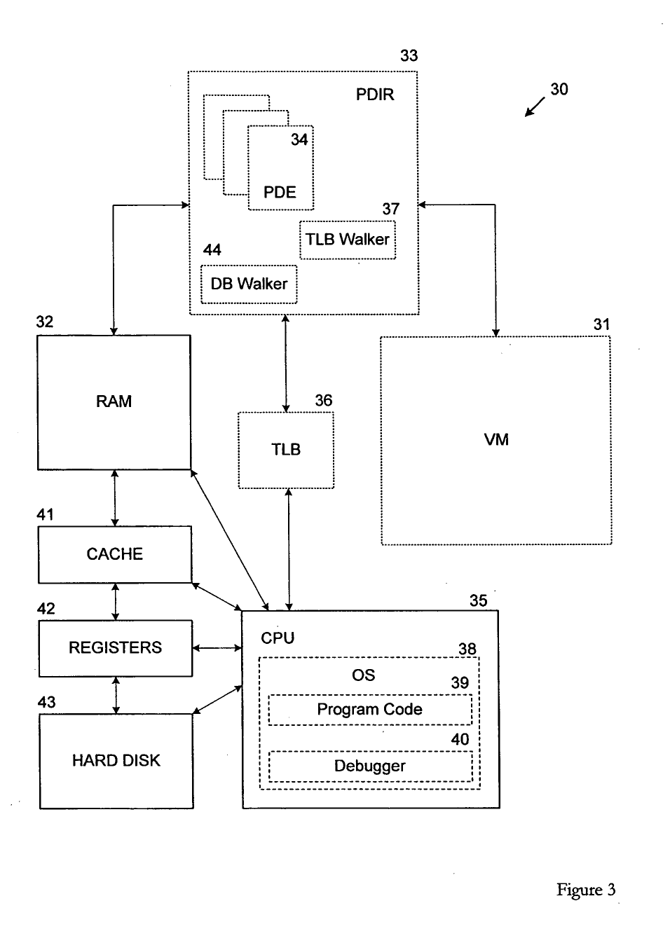

Referring to FIG. 3, the system 30 according to an embodiment of the invention, in a similar way to the conventional system 10, includes a virtual memory array 31 mapped onto physical memory 32, in this case random access memory (RAM), using a list of virtual to physical address translations stored in a page directory (PDIR) 33. The PDIR 33 is, in this example, stored in a portion of the RAM 32, although in alternative examples a separate memory or a different type of memory could be used. Each page translation forms a page directory entry (PDE) 34 within the page directory 33. The system 30 also includes a CPU 35 that includes a TLB 36. The CPU 35 is a Hewlett Packard precision architecture (HPPA) compatible processor, although other processors can be used, such as Itanium™ compatible processors. The system 30 also includes a TLB hardware walker 37, which is a CPU hardware component for searching the PDIR 33 for PDEs 34, and the CPU 35 runs an operating system environment 38, within which program code 39 to be debugged and a debugger 40 can be operated. The system 30 also includes cache memory 41, CPU registers 42 and a hard-disk 43. Additionally, the system 30 comprises a data breakpoint (DB) hardware walker 44.

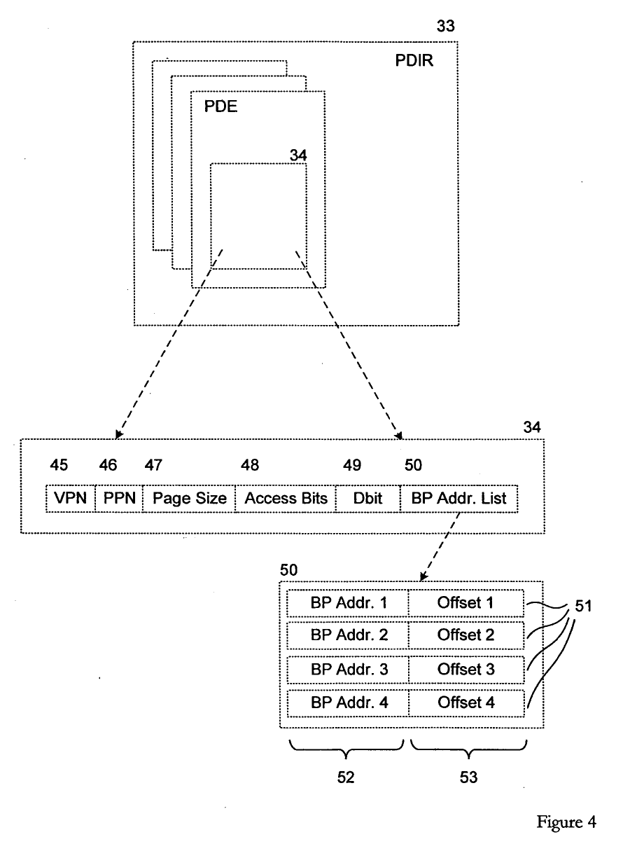

A page directory entry 34 of the system of FIG. 3 is illustrated in FIG. 4. The PDE 34 includes a virtual page number (VPN) 45, a physical page number (PPN) 46, the virtual page size 47, access bits 48, a debug bit (Dbit) 49 and a list 50 of breakpoint (BP) addresses 51. In an alternative example, the list 50 of breakpoint addresses 51 may comprise an associated extended portion of the PDE 34, rather than residing within the PDE 34 itself. The breakpoint addresses 51 each comprise a single virtual memory address 52 followed by a range 53. The range 53 is used to indicate, if necessary, a range of memory locations, starting from the single virtual memory address 52, for which data breakpoints are to be implemented. The virtual memory address 52, in the present example, is indicated by its 12-bit virtual offset component only, since the virtual page number of the address 52 is the page corresponding to the particular PDE 34 in which the virtual memory address 52 is listed.

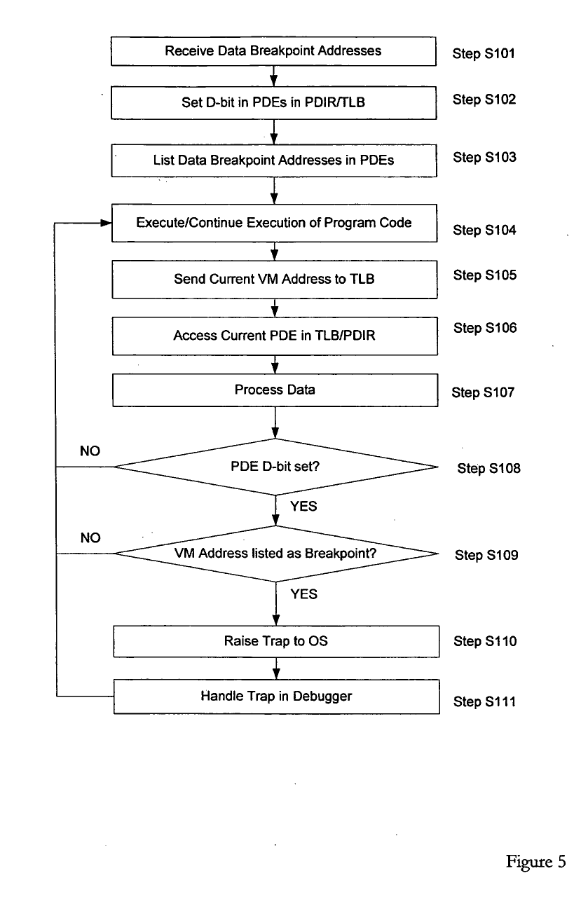

FIG. 5 is a flow diagram illustrating the steps performed by the system 30 in debugging program code 39, also referred to herein as a program file, using data breakpoints supported by virtual memory.

The data breakpoint addresses are received (S101). These could be entered manually by a user, or determined by the debugger 40, for instance in response to a user entering a variable name such as ‘var’. The Dbits 49 of the PDEs 34 corresponding to the data breakpoint addresses are set from value ‘0’ to value ‘1’ in the PDIR 33 and accordingly the TLB 36 (S102). The data breakpoint addresses 51 are also inserted into the breakpoint list 50, as single virtual memory addresses 52. A range 53 can be additionally included where a number of consecutive data breakpoints are to be listed. The program code 39 to be debugged is then executed (S104) by the CPU 35 and, when access to a physical memory address is required, its corresponding virtual memory (ATM) address, referred to as the ‘current’ virtual memory address, is checked in the TLB 36 (S105). It is determined whether the PDE 34 associated with the current virtual memory address is present and, if not, TLB hardware walker 37 is activated to retrieve the PDE 34 from the PDIR 33 in a conventional manner. Once the appropriate PDE 34 has been located, the data stored at the physical memory address corresponding to the current virtual memory address is processed by the CPU 35 as required (S107).

It is then determined whether the current PDE 34 has its Dbit 49 set to ‘1’ (S108). If not, this indicates that a data breakpoint is not set for any of the addresses corresponding to the current PDE 34. Accordingly, the current virtual memory address is not a breakpoint address and therefore execution of the program code 39 is continued (S104).

Alternatively, in the event that the current PDE 34 has its Dbit 49 set to ‘1’ (S108), the data breakpoint hardware walker 44 is activated to search the breakpoint address list 50 of the current PDE 34 in the PDIR to determine whether any of the breakpoint addresses 51 listed correspond to the current virtual memory address, including whether the current virtual memory address is within a range 53 set for any of the breakpoint addresses in the PDE 34 (S109). In this example, the data breakpoint hardware walker 44 searches the PDE data breakpoint addresses 51 linearly, although alternatively a hash function could be used. If the breakpoint addresses 51 listed in the current PDE 34 do not correspond to the current virtual memory address, the current virtual memory address is not a breakpoint address and therefore execution of the program code 39 is continued (S104). Alternatively, in the event that a data breakpoint address 51 does correspond to the current virtual memory address provided to the TLB 36, the TLB 36 raises a trap to the operating system (OS), which has the result of holding program execution (S110).

The trap to the operating system is handled initially by a virtual memory trap handler, which passes control to the debugger 40 (S111). In alternative examples, the trap can be handled by other means, for instance a debug trap handler. The debugger 40 performs debugging actions that, in the present example, are user defined actions. For instance the current execution stack may be traced or the procedure or line of the program code at which execution is halted may be analysed. The data breakpoint address can be analysed to determine what data has been written to it. Debugging actions can be predefined, for instance specified in a look-up table accessible by the debugger 40. Execution of the program code 39 is again resumed (S104) and steps S104 to S111 repeated until execution of the program code 39 is completed.

Whilst the system 30 of FIG. 3 includes a data breakpoint walker 44 for searching the breakpoint address list 50 of PDEs 34 that have their Dbits 49 set to ‘1’, this could alternatively be performed by the TLB walker 37, for instance having extended functionality. In this case, the data breakpoint walker 44 is not required and can therefore be omitted. It is also possible that a data breakpoint walker 44 is implemented in systems that do not include a TLB walker 37. Certain processor architectures include separate data and instruction TLBs, in which case the TLB walker 37 and/or the data breakpoint walker 44 can be limited to use with the data TLB only.

In the present example, enabling and disabling of the data breakpoint walker 44 and TLB walker 37 is performed by setting the value of respective control bits (not illustrated) stored in one of the CPU registers 42. However, alternative arrangements are possible. For instance, only a single one of the hardware walkers 37, 44 may be controlled in this way using control bits. Alternatively, the CPU 35 can be configured to operate in a debug mode, this being a mode in which the data breakpoint walker 44 is enabled. Accordingly, hardware checks performed by the data breakpoint walker 44 can be limited to only cases when the CPU 35 is in the debug mode. The debug mode can, for instance, be defined using a bit in the Processor Status Word (PSW) associated with the CPU 35, the bit, for instance, being either set or unset to a particular value when the debug mode is required.

In the present example, the data breakpoint hardware walker 44 searches the data breakpoint list 50 of PDEs 34 in the PDIR 33. However, in alternative examples, the data hardware walker 44 may be configured to search the PDEs 34 in the TLB 36.

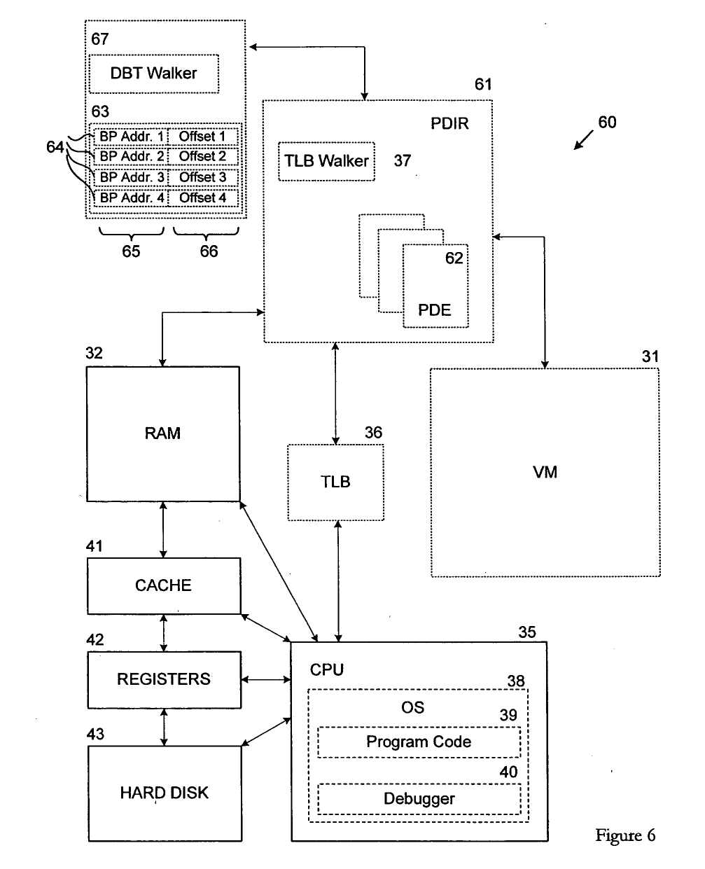

FIG. 6 illustrates a further system 60 according to the invention. This system 60 includes equivalent components to the system 30 of FIG. 3, except that a PDIR 61 is provided having PDEs 62 that do not include a data breakpoint address list 50. The PDEs 62 do, however, include a Dbit 49. A data breakpoint address table (DBT) 63 is used to store data breakpoint addresses 64. As before, the data breakpoint addresses 64 comprise a single virtual memory address 65 followed by a range 66 indicating, if required, a range of memory locations for which data breakpoints are to be implemented. The data breakpoint table 63 is accessed by a data breakpoint walker 67 located within the CPU 35. In order that a hardware walker can be used to access the data breakpoint address table 63, the table 63 is located in equivalently mapped memory (not shown). In alternative examples, the data breakpoint table 63 can be in virtual memory.

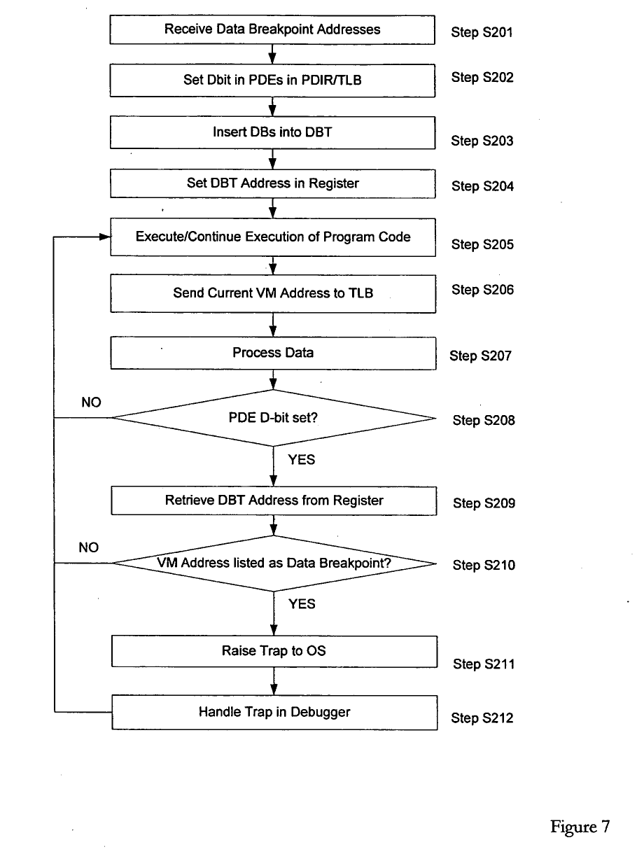

FIG. 7 illustrates the steps performed according to an embodiment of the invention by the system 60 of FIG. 6 in debugging program code 39 using data breakpoints supported by virtual memory.

The data breakpoint addresses are received (S201) and the Dbits 49 of their corresponding PDEs 62 are set from value ‘0’ to value ‘1’ in the PDIR 61 and accordingly the TLB 36 (S202). The data breakpoint addresses 64 are also inserted into the data breakpoint table 63, as single addresses 65 together with a range 66 where required (S203). The memory address of the base of the array forming the data breakpoint table 63 is then stored in a CPU register 42 for future reference (S204). The program code 39 to be debugged is then executed by the CPU 35 (S205) and, when access to a physical memory address is required, its corresponding virtual memory (VM) address, referred to as the ‘current’ virtual memory address, is checked in the TLB 36 (S206). If the PDE 62 associated with the current virtual memory address is not present, the TLB hardware walker 37 is activated to retrieve the PDE 62 from the PDIR 61 in a conventional manner. Once the appropriate PDE 34 has been located, the data stored at the physical memory address corresponding to the current virtual memory address is processed by the CPU 35 as required (S207).

It is then determined whether the current PDE 62 has its Dbit 49 set to ‘1’ (S208). If not, this indicates that a data breakpoint is not set for the current virtual memory address and therefore execution of the program code 39 is continued such that a new current virtual memory address can be processed (S205).

Alternatively, in the event that the current PDE 62 has its Dbit 49 set to ‘1’ (S208), the data breakpoint walker 67 retrieves the memory location of the data breakpoint table 63 from the registers 42 (S209). The data breakpoint table walker 67 is then activated to search the data breakpoint table 63 at the retrieved memory location to determine whether any of the breakpoint addresses 64 listed correspond to the current virtual memory address, including whether the current virtual memory address is within a range 66 set for any of the breakpoint addresses 64 (S210). In this example, the data breakpoint table walker 67 searches the data breakpoint table 63 linearly, although alternatively a hash function could be used. If the breakpoint addresses 64 listed in the data breakpoint table 63 do not correspond to the current virtual memory address, execution of the program code 39 is continued (S205) and the CPU 35 calls any further virtual memory addresses that are required.

Alternatively, in the event that a data breakpoint address 64 does correspond to the current virtual memory address provided to the TLB 36, the TLB 36 raises a trap to the operating system (OS), which has the result of holding program execution (S211).

The trap to the operating system is handled initially by a virtual memory trap handler, which passes control to the debugger 40 (S212). The debugger 40 performs user defined debugging actions, for instance actions appropriate to the data breakpoint that has caused the trap to be raised. Execution of the program code 39 is again resumed (S205) and steps S205 to S212 repeated until execution of the program code 39 is completed.

Whilst the system 60 of FIG. 6 includes a data breakpoint walker 67 for searching the data breakpoint table 63 when a PDE 62 has its Dbit 49 set to ‘1’, this could alternatively be performed by the TLB walker 37. In this case, the data breakpoint walker 67 is not required and can be omitted.

Whilst specific embodiments of the invention have been described, other implementations are possible. For instance, rather than setting the Dbit 49 to have value ‘1’ in the PDEs 34, 62 (S102-S202), alternative implementations are possible. For instance, a Dbit value of ‘0’ could indicate that a PDE 34, 62 has breakpoints associated with it, or a bit or sequence of bits other than the Dbit 49 could be used.

In a further alternative example, rather than being a specific virtual memory address 52, 65 or a virtual address 52, 65 together with a range 53, 66, the data breakpoint addresses can be replaced by a hint or indication of a segment or portion of the virtual page in which the data breakpoint address occurs.

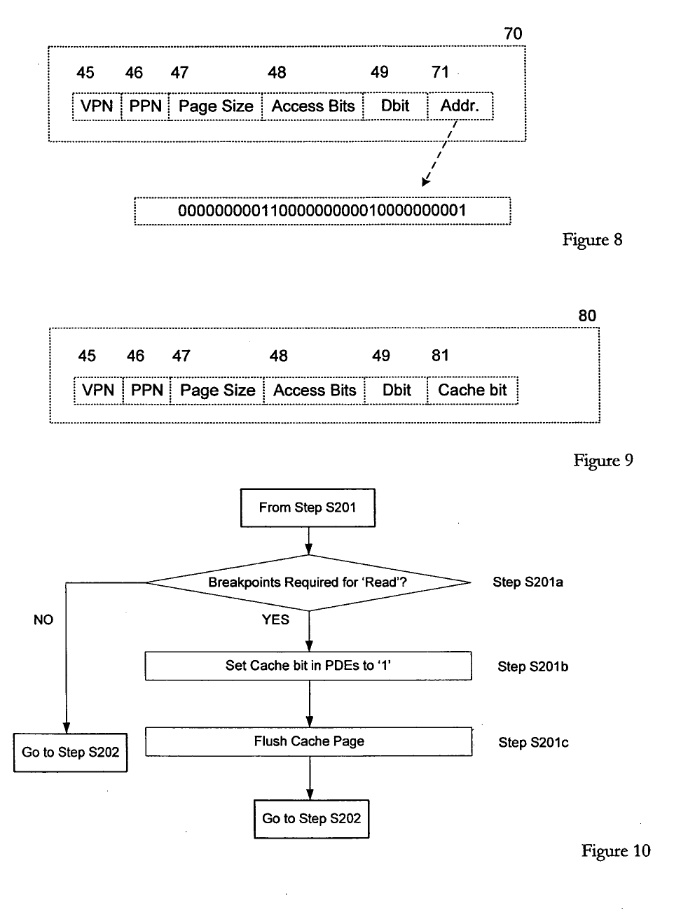

FIG. 8 illustrates an alternative PDE 70 which, rather than including a list 50 of data breakpoint addresses 51, instead includes a 32-bit sequence 71 indicating the portions of the virtual memory page in which data breakpoint addresses reside.

Each virtual memory page, in the present example, comprises a plurality of virtual memory address, each address within the page being defined by a 12-bit sequence, i.e. the virtual offset. Therefore, virtual memory pages have a page size 47 of 2ˆ12 or 4096 bytes. In this example, each respective bit of the 32-bit sequence 71 corresponds to a respective 128-byte segment of the virtual page. The least significant bit of the 32-bit sequence 71 is set to ‘1’. This indicates that a data breakpoint address is located in the first 128 bytes of the 4096 bytes in the virtual memory page. The eleventh bit (counting from the least significant bit) of the 32-bit sequence 71 is also set to ‘1’, indicating that a data breakpoint address is located within the eleventh 128 byte segment (between the 1280^{th} byte and the 1408^{th} byte of the page) of the 4096 bytes of the virtual memory page, or is within the offset address range 010100000000 to 010110000000. The 22^{nd} and 23^{rd} bits in the 32-bit sequence are also set to ‘1’, again indicating that the 22^{nd} and 23^{rd} 128 byte segments of the virtual memory page include breakpoint addresses. The bits located in positions other than 1, 11, 22 and 23 are set to value ‘0’.

The alternative PDE 70 can, for instance, be used in the system 30 of FIG. 3, with some modifications to the processes performed. For instance, referring to FIG. 5, when determining whether a current virtual memory address is listed as a breakpoint address, rather than comparing the virtual memory address to specific data breakpoint addresses 52 and offset ranges 53 listed in a PDE 34, it is determined whether the current virtual memory address is within one of the virtual memory page segments specified in the sequence 71 of the PDE 70 (S108). If so, after the trap has been raised to the operating system 38 (S109) the trap is handled in the debugger 40 (S110), and the debugger 40 consults a separate debug list of specific data breakpoint addresses to determine whether the current virtual address is one of them. If not, execution of the program code 39 is resumed (S104). If, however, the current virtual memory address is listed as a data breakpoint address in the separate debug list, the debugger 40 continues to handle the trap as normal and the remaining step of the process performed as usual (S111).

The sequence 71 can also be applied in place of the data breakpoint table 63 of the system 60 depicted in FIG. 6. Appropriate changes to the operating procedures of the system 60 would be necessary.

The alternative PDE 70 may, instead of including a 32-bit sequence 71, include a list of 5-bit sequences, each 5-bit sequence indicating a 128-byte segment or portion of the virtual memory page in which a data breakpoint is located. For instance, a first 5-bit sequence could be ‘00000’, having the decimal value ‘0’. This indicates that a data breakpoint address is located in the first 128 bytes of the 4096 bytes in the virtual memory page. A second 5-bit sequence could have the value ‘00110’, therefore having the decimal value ‘6’, indicating that a data breakpoint address is located within the seventh 128 byte segment (between the 768^{th} byte and the 896^{th} byte) of the 4096 bytes of the virtual memory page, or is within the offset address range 001100000000 to 001110000000.

FIG. 9 illustrates a further alternative PDE 80 according to the invention. In this example, the PDE 80 includes a cache bit 81 used to indicate whether caching of a physical memory page corresponding to the virtual page associated with the PDE 80 is allowable.

The further alternative PDE 80 can, for instance, be used in place of the PDE 62 of the system 60 depicted by FIG. 6. Additional processing steps to those illustrated in the flow diagram of FIG. 7 are required as depicted in the flow diagram of FIG. 10. In particular, once the data breakpoint addresses have been received (S201) it is determined whether monitoring of ‘reads’ of the data stored at the data breakpoint addresses is required (S201a). If not, caching of the data associated with the data breakpoint addresses is allowable and the process therefore continues as previously described (S202). If, however, data breakpoints are required for the situation in which the data stored at particular memory addresses is accessed but not modified by the CPU 35, the cache bits 81 of each of the PDEs 80 in which the data breakpoints fall is set to ‘1’ to indicate that caching of the physical memory pages associated with these PDEs 80 is not allowed. This ensures that the data from the physical addresses will not be cached in the cache memory 41. The cache is also flushed of data corresponding to the PDEs 80 (step S201c).

Although the systems 30, 60 have been described in which execution of the program code 39 is discontinued as a result of a trap being raised to the operating system, the program flow could alternatively be halted in other ways. Furthermore, although architectures including hardware walkers have been described, the invention is not limited to use of hardware walkers for accessing PDEs and/or data breakpoint tables; other implementations would be apparent to the skilled person.

Whilst systems 30, 60 have been described having single processors 35, the invention is also applicable in multi-processor systems. Application of the invention to such systems can have the benefit of enabling program errors caused by unhandled timing window problems to be corrected. For instance, a memory location shared by first and second CPUs can be set as a data breakpoint address. During program code execution, execution threads from the first and second CPUs could cause this shared memory location to be accessed and/or modified separately by each CPU within a short space of time. Due to the speed of accessing data breakpoint information using hardware walkers, a trap can be raised to the operating system following a first modification of the shared memory location by the first CPU and before a second modification by the second CPU occurs. This can therefore ensure that the shared memory location can be analysed using the debugger following the first modification and before the second modification.

Although accesses and modifications of memory locations by CPUs 35 have been described, the invention is also applicable to memory location modifications by multiple fast input/output devices. In this case, the use of hardware walkers can, for instance, be advantageous in ensuring that timing window problems causing consecutive modifications of a particular memory location within a short space of time can be corrected.

1. A method of debugging program code, the method comprising:
executing the program code;
receiving a virtual address associated with the program code, the virtual address being an address within a virtual page;
accessing first breakpoint data, the first breakpoint data indicating whether one or more breakpoint addresses are associated with the virtual page;
in the event that the first breakpoint data indicates that one or more breakpoint addresses are associated with the virtual page, accessing second breakpoint data which defines a portion of the virtual page associated with the one or more breakpoint addresses; and,
in the event that the virtual address is within the defined portion of the virtual page, discontinuing execution of the program code.

2. A method according to claim 1, wherein the defined portion comprises a single breakpoint address, comprising discontinuing execution of the program code when the virtual address is the breakpoint address.

3. A method according to claim 1, wherein the defined portion comprises a range of addresses.

4. A method according to claim 3, wherein the range of addresses are all breakpoint addresses.

5. A method according to claim 3, wherein at least one of the addresses in the range of addresses comprises a breakpoint address.

6. A method according to claim 1, comprising disabling caching of data located at one or more physical addresses, at least one of the physical addresses corresponding to a breakpoint address.

7. A method according to claim 1, comprising deleting data stored at one or more cache addresses in cache memory, at least one of the cache addresses corresponding to a breakpoint address.

8. A method according to claim 1, wherein the program code is operable to run within an operating system environment on a computer and wherein the step of discontinuing execution of the program code comprises raising a trap to the operating system.

9. A method according to claim 1, further comprising accessing the second breakpoint data using a hardware walker.

10. A method according to claim 9, further comprising adjusting control data for enabling or disabling the hardware walker.

11. A method according to claim 1, wherein the second breakpoint data is associated with a page directory entry of a page directory.

12. A method according to claim 1, wherein the second breakpoint data is stored in a table other than a page directory.

13. A method according to claim 12, comprising storing a value indicative of the memory location of the table in a register.

14. Apparatus for debugging program code, the apparatus comprising:
means for executing the program code;
means for receiving a virtual address associated with the program code, the virtual address being an address within a virtual page;
means for accessing first breakpoint data, the first breakpoint data indicating whether one or more breakpoint addresses are associated with the virtual page;
means for accessing second breakpoint data in the event that the first breakpoint data indicates that one or more breakpoint addresses are associated with the virtual page, the second breakpoint data defining a portion of the virtual page associated with the one or more breakpoint addresses; and,
means for discontinuing execution of the program code in the event that the virtual address is within the defined portion of the virtual page.

15. Apparatus according to claim 14, wherein the defined portion comprises a single breakpoint address and the means for discontinuing execution of the program code does so when the virtual address is the breakpoint address.

16. Apparatus according to claim 14, wherein the defined portion comprises a range of addresses.

17. Apparatus according to claim 14, comprising means for disabling caching of data located at one or more physical addresses, at least one of the physical addresses corresponding to a breakpoint address.

18. Apparatus according to claim 14, comprising means for deleting data stored at one or more cache addresses in cache memory, at least one of the cache addresses corresponding to a breakpoint address.

19. Apparatus according to claim 14, wherein the program code is operable to run within an operating system environment on a computer and wherein the means for discontinuing execution of the program code does so by raising a trap to the operating system.

20. Apparatus according to claim 14, further comprising a hardware walker for accessing the second breakpoint data.
